(19) United States
(12) Patent Application Publication
(10) Pub. No.: US 2010/0188690 A1
(43) Pub. Date: Jul. 29, 2010

(54) DATA CONVERSION APPARATUS, PRINTING APPARATUS, COMPUTER READABLE MEDIUM, AND DATA CONVERSION METHOD

(75) Inventor: Hisashi Moriya, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/541,614

(22) Filed: Aug. 14, 2009

(30) Foreign Application Priority Data
Jan. 29, 2009 (JP) 2009-018472

(51) Int. Cl. G06F 15/00; G06F 17/00

(52) U.S. Cl. 358/1.15; 715/274

(57) ABSTRACT

A data conversion apparatus is provided with a reception unit, a conversion unit, a display and an edit unit. The conversion unit converts first data having a first format for printing received by the reception unit into second data having a second format for display. The display displays the converted second data. The edit unit performs a display-purpose edit with respect to at least one of the first data or the second data.

### CROSS-REFERENCE TO RELATED APPLICATIONS

This application is based upon and claims priority under 35 USC 119 from Japanese Patent Application No. 2009-018472 filed Jan. 29, 2009.

### BACKGROUND

1. Technical Field

The present invention is related to a data conversion apparatus, a printing apparatus, a computer readable medium, and a data conversion method.

2. Related Art

An information processing apparatus such as a personal computer or a host computer transmits, to a printing apparatus which is connected thereto via network, print data having a print language format which is interpretable by the printing apparatus. The printing apparatus converts the print data having the print language format into print data having a bitmap format and carries out printing based on the converted print data having the bitmap format.

### SUMMARY

According to an aspect of the invention, there is provided a data conversion apparatus including: a reception unit that receives first data having a first format which is used for printing; a conversion unit that converts the first data received by the reception unit into second data having a second format which is used for display; a display that displays the second data converted by the conversion unit; and an edit unit that performs a display-purpose edit with respect to at least one of the first data or the second data.

### BRIEF DESCRIPTION OF THE DRAWINGS

Exemplary embodiments of the present invention will be described in detail based on the following figures, wherein:

FIG. 1 is a diagram for schematically showing an arrangement of an enterprise printing apparatus according to a first exemplary embodiment of the present invention.

FIG. 2 is a structural diagram for showing a communication line network as to the enterprise printing apparatus of the first exemplary embodiment, an image processing apparatus, a server, and a host computer.

FIG. 3 is a block diagram for representing hardware resources of the server.

FIG. 4 is a functional block diagram for describing a print job data management control executed in a main controller of the server, according to the first exemplary embodiment.

FIG. 5 is a flow chart for describing a print job data management control routine, according to the first exemplary embodiment.

FIG. 6 is a functional block diagram for describing a print job data management control executed in a main controller of a server, according to a second exemplary embodiment of the present invention.

FIG. 7 is a flow chart for describing a print job data management control routine, according to the second exemplary embodiment.

FIG. 8 indicates a representation obtained when the edit is not carried out in the first exemplary embodiment and the second exemplary embodiment in such a case in which a both-side printing, a printing with a front cover, and a duplex copy have been designated.

FIG. 9 indicates a representation obtained when the edit is carried out in the first exemplary embodiment and the second exemplary embodiment in such a case in which a both-side printing, a printing with a front cover, and a duplex copy have been designated.

FIG. 10 indicates a representation obtained when the edit is not carried out in the first exemplary embodiment and the second exemplary embodiment in such a case in which a both-side printing and a short-edge binding have been designated.

FIG. 11 indicates a representation obtained when the edit is carried out in the first exemplary embodiment and the second exemplary embodiment in such a case in which a both-side printing and a short-edge binding have been designated.

### DETAILED DESCRIPTION

A print language format is a data format which is used for printing and which is interpretable by a printing unit. The print language format is, for example, PS (Post Script) of a page description language, LCDS (Line Conditioned Data Stream) and IPDS (Intelligent Printer Data Stream) of print data formats. Various sorts of print languages have been proposed by manufactures of printing units. Note that there is a case in which a PDF (Portable Document Format) document format and the like are rarely used as such a format which is used not only for display but also for printing. However, in this exemplary embodiment, a data format which is used for printing but which is not used for display is defined as the print language format.

An electronic document format is a data format which is used for display, and which is interpretable by a display which displays an electronic document on a display screen. The electronic document format is, for instance, a PDF document, a WORD (Microsoft Office Word) document, and an EXCEL (Microsoft Office Excel) spreadsheet. These electronic document formats are interpreted by dedicated application software, and then, the interpreted electronic documents are displayed on a display screen.

### First Exemplary Embodiment

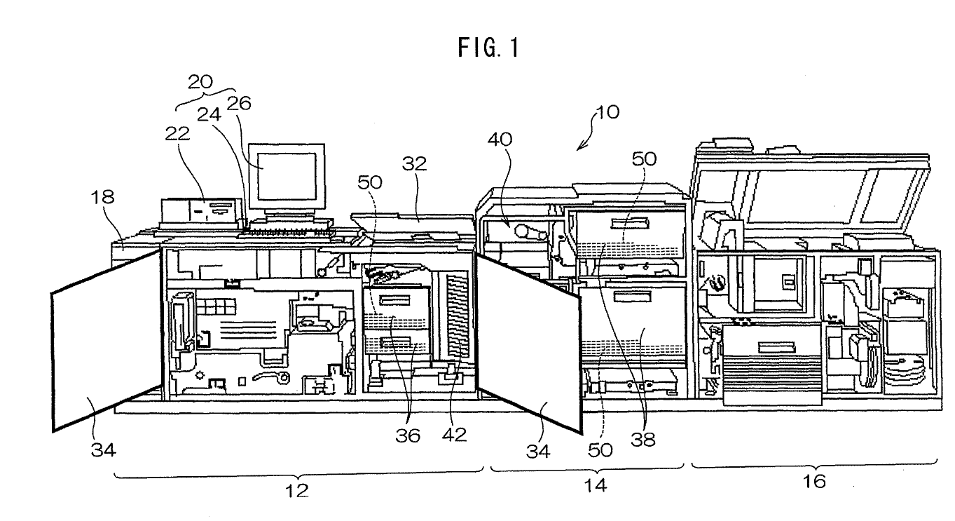

In FIG. 1, an enterprise printing apparatus 10 according to a first exemplary embodiment of the present invention is shown. The enterprise printing apparatus 10 is provided in enterprise system, for example, administration of all the central corporate activities, such as sales management, production management, HR, payroll etc. The enterprise printing apparatus 10 is broadly divided into an image forming unit 12, a paper storage unit 14, and a post-processing unit 16, in sequence from the left hand side in FIG. 1.

A main controller 20 for controlling an entire system of the enterprise printing apparatus 10 is provided on an upper face of a housing 18 of the above-described image forming unit 12. The main controller 20 is equipped with a controller main body 22, a keyboard 24, and a display 26.

An opening unit having a rectangular shape is provided at the right hand side (namely, on the top face of image forming unit 12) of the main controller 20, as viewed in FIG. 1. An openable lid 32 is mounted on the opening unit.

The image forming unit 12 is covered by the housing 18. The image forming unit 12 is equipped with a light scanning unit, a photosensitive drum, a developing unit, a transfer unit, and a fixing unit. The light scanning unit scans a light beam which is emitted in response to image data supplied from the main controller 20. The photosensitive drum receives the light beam scanned by the light scanning unit and forms a so-called latent electrostatic image. The developing unit supplies a developer such as a toner onto the latent electrostatic image formed on the photosensitive drum and develops the electrostatic latent image. The transfer unit transfers an image developed by the developing unit onto a recording paper. The fixing unit fixes the image transferred onto the recording paper. The process in the above chain will be referred to as “an entire image forming process”. Also, “an image forming process” will be referred to as a “printing”, if necessary.

Substantially all the area of a front face of the housing 18 in which the above-described image forming unit 12 is accommodated is open, as shown in FIG. 1. One pair of so-called double door type opening/closing doors 34 are mounted on the front face.

When maintenance operating of the image forming unit 12 is carried out, since one pair of the opening/closing doors 34 is opened, a maintenance operating space is provided of substantially the same surface area as that of the whole face of the housing 18.

A recording-purpose paper 50 which is fed to the transfer unit of the image forming unit 12 is selectively taken out from plural trays 36 provided below the openable lid 32, or from plural trays 38 provided in the paper storage unit 14. In other words, these plural trays 36 and 38 are capable of storing recording papers 50 which have different sizes (and sometimes of the same size). In response to an instruction issued from the image forming unit 12 based upon an instruction issued from the main controller 20, one or other of the trays 36 or 38 is selected, and thus, for example, a recording paper 50 is fed out in sequence from the uppermost sheet thereof.

The recording paper 50 applied in the first exemplary embodiment is, for instance, a form on which a predetermined image (a recording paper printing image) has been previously made.

As shown in FIG. 1, a top portion of the paper storage unit 14 constitutes a conveyance unit 40 which conveys the recording paper 50 printed by the image forming unit 12. In other words, when a post-processing is required, a recording paper 50 printed by the image forming unit 12 is conveyed via the conveyance unit 40 to the post-processing unit 16. To the contrary, a recording paper 50 which is not requiring to be processed by the post-processing unit 16 is discharged to a discharge tray unit 42 arranged below of the openable lid 32.

The post-processing unit 16 may also be referred to as a finishing unit. The finishing unit performs treating process such as bookbinding, fastening, hole opening, and folding, and further executes collation process by job or by a number of copies.

There is a case in which a direction of top and bottom sides of image data may be reversed, magnification may be changed, and image data may be repeatedly used based upon designated print job attributes.

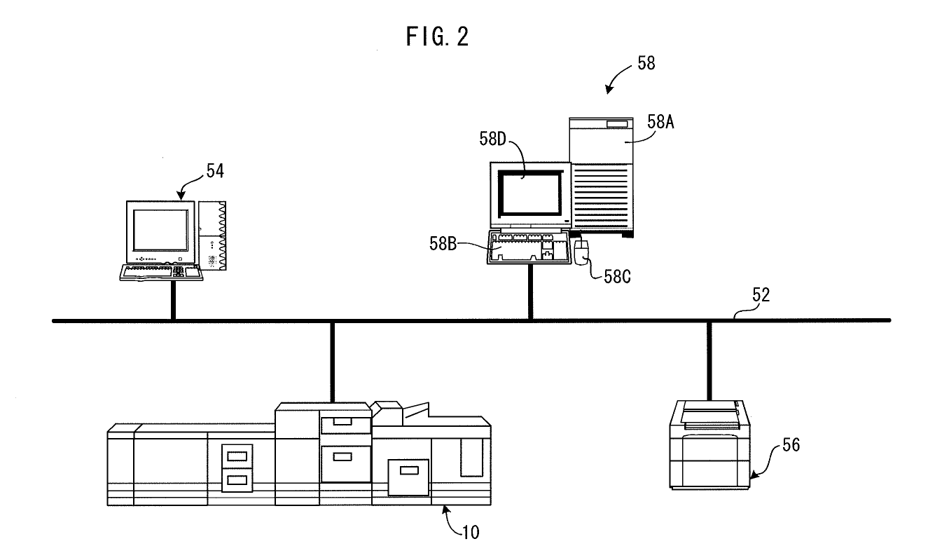

As shown in FIG. 2, the enterprise printing apparatus 10 of the first exemplary embodiment is connected via a communication line network 52 to a host computer 54 and is capable of transmitting and/or receiving data with the host computer 54. An image processing apparatus 56 having a different structure from that of the above-described enterprise printing apparatus 10 is connected to the communication line network 52. The communication line network 52 may be a so-called limited range network such as LAN (Local Area Network), a WAN (Wide Area Network) or the Internet.

Print job data are stored in the host computer 54. The print job data are data which is to be printed by the enterprise printing apparatus 10 and the image processing apparatus 56, which are connected to the communication line network 52.

The image processing apparatus 56 has at least a printer function among the printer function, a copy function, and a facsimile function. If the image processing apparatus 56 has two or more functions among these functions, the image processing apparatus 56 may be referred to as a “multi-function apparatus.” Since a structure of the printer function of the image processing apparatus 56 is substantial identical to the structure of the image forming unit 12 shown in FIG. 1, a detailed explanation thereof will be omitted. That is, the structure of the image forming unit 12 is, for example, a so-called “Xerography” in which an electrostatic latent image is formed and developed by using a toner. As the configuration of the printer function, an inkjet printer or a thermal transfer printer may be used.

A printing capability of the enterprise printing apparatus 10 whose structure is explained in FIG. 1 corresponds to a relatively large amount of printing. A printing capability of the image processing apparatus 56 corresponds to a relatively small amount of printing.

In the first exemplary embodiment, the enterprise printing apparatus 10 (refer to FIG. 1) has such a role that the enterprise printing apparatus 10 accepts print job data from the host computer 54 so as to execute a large amount of printing (will be referred to as “main printing process” hereinafter). On the other hand, the image processing apparatus 56 has such a role that, for example, in a case in which, after the large amount of printing by the enterprise printing apparatus 10 has been once accomplished, a portion of the print is required to be reprinted, the image processing apparatus 56 executes a small amount of printing based upon the print job data (will be referred to “reprinting process” hereinafter). The reprinting may be a relatively large amount of printing or a relatively small amount of printing.

The print job data received from the host computer 54 is stored as electronic data in the server 58.

The image processing apparatus 56 reads out necessary print job data from the server 58 so as to execute an image forming process.

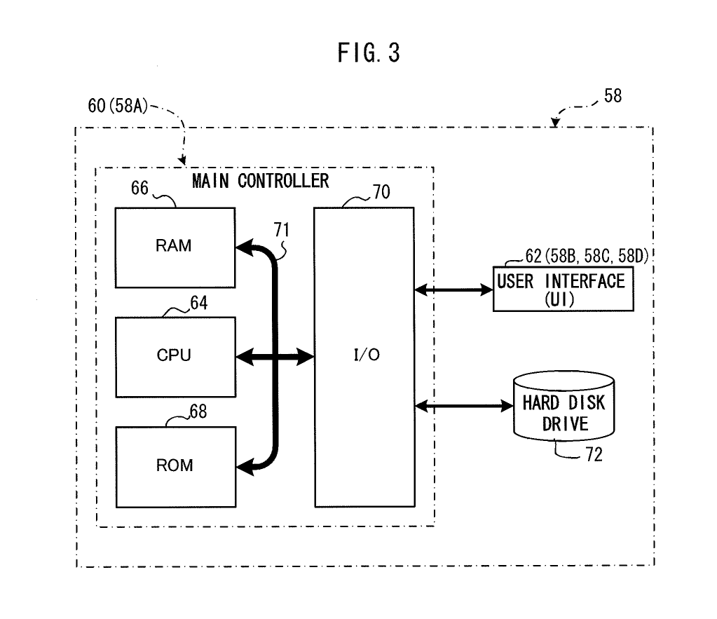

FIG. 3 shows a structure of hardware resources of the server 58. The server 58 includes a main controller 60 (tower 58A shown in FIG. 2), and a user interface 62 (keyboard 58B, mouse 58C, and monitor 58D shown in FIG. 2). The main controller 60 is provided with a CPU (central processing unit) 64 functioning as a microcomputer, a RAM (random access memory) 66, a ROM (read-only memory) 68, an I/O (input/output) port 70, and a bus 71 such as a data bus and a control bus. The bus 71 connects the above-described structural elements of the main controller 60 with each other.

A hard disk drive 72 is connected to the I/O port 70, while the hard disk drive 72 functions as a storage medium having a large storage capacity which stores the print job data and the like.

The print job data contains image data and control data. The image data is actually printed on the recording paper 50. The control data represents general-purpose attributes and special attributes related to process specific to enterprise printing at the printing based on the image data, as shown in Table 1. The print job data is described in the print language format. A print language called as LCDS (Line Conditioned Data Stream) is used as an example in the present exemplary embodiment. As the print language format, any other print languages than LCDS may be alternatively used, for instance, PS (Post Script), IPDS (Intelligent Printer Data Stream) and the like may be used. Note that the control data related to the first exemplary embodiment is not limited only to the attributes represented in Table 1.

TABLE 1

| Print job | |
|---|---|
| attributes | Contents |
| BINDING | binding direction (short edge/long edge) |
| COLLATE | sorting (by page/by number of copies) |
| COPIES | copy number (by page/by number of copies) |
| DUPLEX | both-side printing/one-side printing |
| PMODE | image processing direction (vertical/horizontal) |
| FACE-UP | cover page face direction of image process result |
| | (upper cover page/lower cover page) |
| FEED | paper feed (selection of recording paper feed mechanism) |
| N-UP | printing of a single page with N-divisions |
| COVER | starting cover page and/or ending cover page is fed from |
| | image |
| | processing paper feed mechanism for cover page |
| PFORM | designate electronic form applied to cover page |
| RTEXT | designate character string whose image is processed on |
| | cover page |

Since the control data is present, when the image processing apparatus 56 performs reprinting, the image processing apparatus 56 is capable to execute a reprinting process under attributes which are equivalent to those when the printing is carried out by the enterprise printing apparatus 10. Examples of attributes based upon the control data at the time of the reprinting process will be given as follows.

(Attribute Example 1)

A paper (bookmark) having different color is sandwiched in a boundary when plural number of copies are printed or in a designated portion.

(Attribute Example 2)

When a both-side printing is carried out in a case in which a total page number is odd, a rear face of a last page is blank.

(Attribute Example 3)

A page is rotated based upon a printing direction and a position near a binding margin with respect to a recording paper 50.

On the other hand, in enterprise printing, in addition to the above-explained “main printing process” and “reprinting process”, another process is provided in order to confirm a content of print job data (which will be referred to as “display confirmation process” hereinafter). In the display confirmation process, for example, a print content is displayed on the monitor 58D which constitutes a portion of the server 58 (it is not limited only to monitor 58D, but a viewer-purpose display device may be prepared).

The display confirmation process is a process that print job data is read from the server 58, and then, the read print job data is displayed on the monitor 58D.

However, since the control data represented in Table 1 is added to the image data in the read print job data, the server 58 performs a conversion process of the image data based upon the control data in a similar manner when the image data is reprinted by the image processing apparatus 56, and thereafter, displays the converted image data on the monitor 58D. At this time, the above-described process of the above attribute examples 1 to 3 at the time of reprinting is also carried out when the display process for the monitor 58D is carried out.

As a result, there is a case in which a second copy and subsequent copies are displayed when plural number of copies of printing is designated; a blank page which corresponds to a rear face is displayed when a both-side printing is designated; and a printed paper is displayed in reversed top and bottom sides based when a printing direction and a binding margin position are designated.

In the first exemplary embodiment, the server 58 performs a display-purpose edit with respect to image data in order to display the image data on the monitor 58D, and then, generates display-purpose data.

In other words, with respect to the same print job data, two sorts of data which are different from each other are generated. The generated two sorts of different data are stored in association with the image data. One of the generated data is selected in response to an instruction for either a reprinting process or a monitor display process, and the instructed process is carried out.

Display-purpose data is data having an electronic document format, which is described in PDF (Portable Document Format) format in the present exemplary embodiment. PDF format is one of formats for electronic documents, and is utilized in order to form an electronic version of a document which is formed by such as a layout software. Not only character information is stored, but also other information such as a font, a character size, a character decoration, an embedded image and layouts is stored in PDF format.

A content of the print job data is displayed by utilizing a presently available application program by using print job data for a printing process and converting the data into display-purpose data, without designing a new application program for directly interpreting the print job data.

When data having a print language format is converted into data having PDF format, namely, when a print-purpose data is converted into a display-purpose data, since a display-purpose edit which will be discussed later in detail is carried out, a useless display, a display which is difficult to view and the like may be suppressed when the data is displayed on the monitor 58D, and as a result, ease of viewing when a user views the edited display-purpose data on the monitor 58D may be improved.

More concretely speaking, the below-mentioned display modes may be suppressed.

(Display Mode 1)

When plural copies of a printed matter are designated, the second and subsequent copies are displayed.

(Display Mode 2)

A blank page of a rear face is displayed when a both-side printing is carried out.

(Display Mode 3)

A printed paper is displayed in reversed top and bottom sides when a printing direction and a binding margin position are designated.

In order to suppress at least one of the above-explained display modes 1 to 3, the display-purpose data is converted from the print job data.

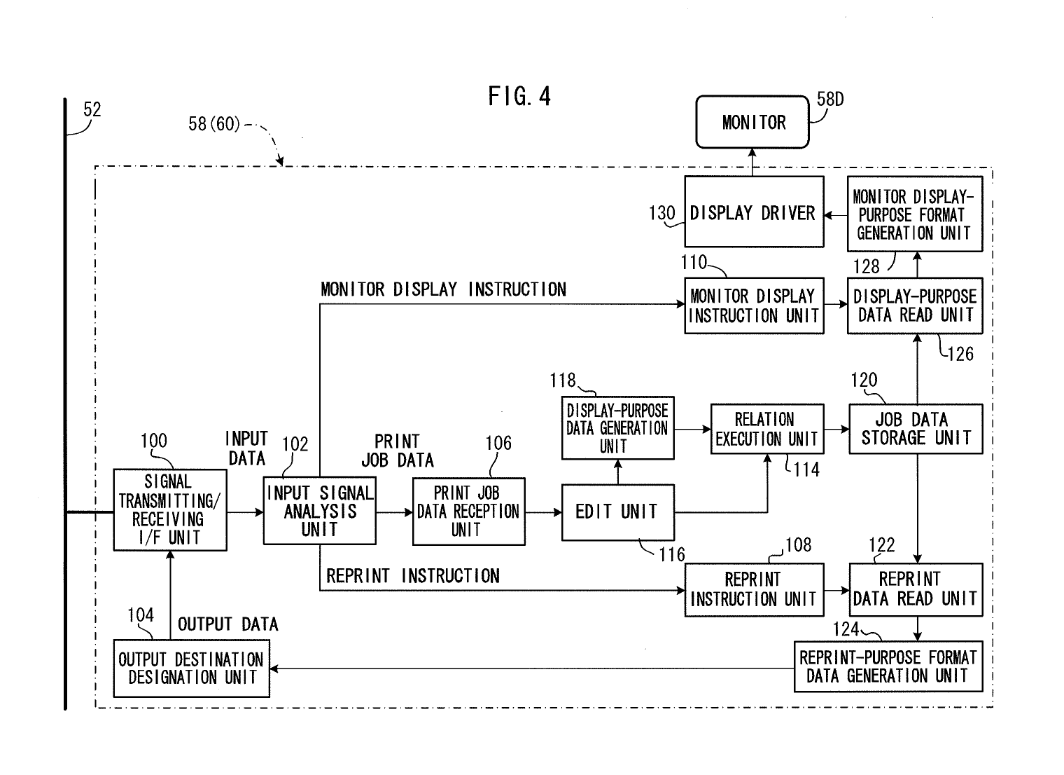

FIG. 4 is a functional block diagram for explaining a print job data management control executed in the main controller 60 of the server 58. The blocks in FIG. 4 are merely classified based upon functions, and therefore hardware structures are not limited to this.

A signal transmitting/receiving I/F (interface) unit 100 is connected to the communication line network 52 so as to manage transmission and reception of signal. That is, when a signal is input from the communication line network 52, the signal transmitting/receiving I/F unit 100 transmits the signal to an input signal analysis unit 102. While the signal transmitting/receiving I/F unit 100 is connected to an output destination designation unit 104, when the signal transmitting/receiving unit 100 receives output data from the output destination designation unit 104, this output data is output to the communication line network 52. The output destination is, for example, the image processing apparatus 56. The input signal analyzing unit 102 is connected to a print job data reception unit 106, a reprint instruction unit 108, and a monitor display instruction unit 110.

As a result of analysis made by the input signal analysis unit 102, when the input data is print job data, this print job data is transmitted to the print job data reception unit 106. The print job data reception unit 106 is used as one example of a reception unit.

An edit unit 116 is connected to the print job data reception unit 106. The edit unit 116 extracts control data from the received print job data. The edit unit 116 extracts the control data from the print job data with reference to a table which stores information of the control data, and then, the edit unit 116 deletes the control data from the print job data. The edit unit 116 is connected to a relation execution unit 114 so as to transmit the control data extracted during the edit to the relation execution unit 114.

The edit unit 116 is connected to a display-purpose data generation unit 118. The edit unit 116 is used as one example of an edit unit.

The display-purpose data generation unit 118 acquires the data having a print language format in which the control data has been deleted from the print job data, and then, analyzes the acquired data to convert into data having an electronic document format. In other words, the data having the print language format in which the control data has been deleted from the print job data is converted into a display-purpose data having an electronic document format which is displayed on the monitor 58D and thus a display-purpose data is generated. The display-purpose data is converted into data having PDF format. The display-purpose data generation unit 118 is connected to the relation execution unit 114. The display-purpose data generation unit 118 transmits the generated display-purpose data to the relation execution unit 114. The display-purpose data generation unit 118 is used as one example of a conversion unit.

As a result, both the display-purpose data and the control data are prepared in the relation execution unit 114, the display-purpose data and the control data are transmitted to a job data storage unit 120 in a state that the display-purpose data and the control data are associated with each other.

In a case in which an analysis result of an input signal made by the input signal analysis unit 102 is a reprint instruction, the input signal analysis unit 102 transmits a reprint instruction signal to the reprint instruction unit 108.

Upon receipt of the reprint instruction signal, the reprint instruction unit 108 outputs an activation signal to a reprint data read unit 122. Based upon the activation signal, the reprint data read unit 122 reads out the display-purpose data and the control data from the job data storage unit 120, and transmits the read data to a reprinting format data generation unit 124.

The reprinting format data generation unit 124 generates reprint-purpose data by formatting for printing based upon the display-purpose data and the control data, and then, transmits the generated reprint-purpose data to the output destination designation unit 104. The output destination designation unit 104 transmits the received reprint-purpose data via the signal transmitting/receiving I/F unit 100 and the communication line network 52 to the image processing apparatus 56.

When an analysis result of an input signal made by the input signal analysis unit 102 is a monitor display instruction, the input signal analysis unit 102 transmits a monitor display instruction signal to the monitor display instruction unit 110.

Upon receipt of the monitor display instruction signal, the monitor display instruction unit 110 outputs an activation signal to the display-purpose data read unit 126. Based upon the activation signal, the display-purpose data read unit 126 reads out the display-purpose data having PDF format from the job data storage unit 120, and transmits the read data to the monitor display-purpose format data generation unit 128.

The monitor display-purpose format data generation unit 128 generates monitor display-purpose data by formatting for monitor display based upon the display-purpose data having PDF format, and then, transmits the generated monitor display-purpose data to a display driver 130. The display driver 130 transmits the received monitor display-purpose data to the monitor 58D.

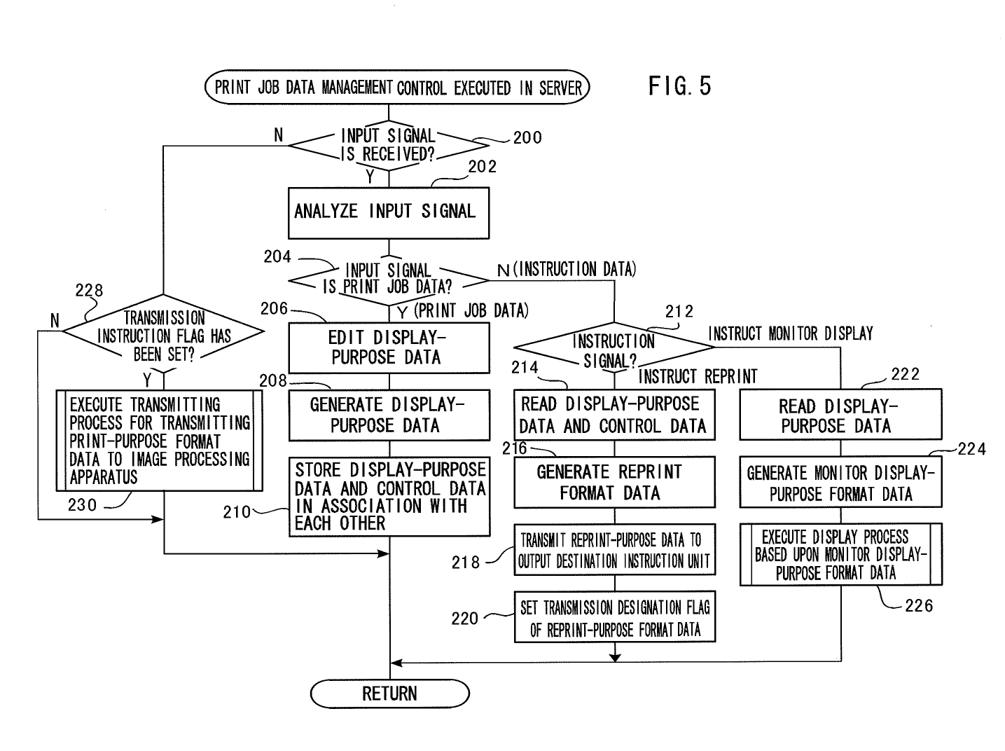

Operation of the first exemplary embodiment with reference to a flow chart shown in FIG. 5 will be described.

In step 200 of the flow chart, a judgment is made whether or not a signal has been received. When the judgment result is affirmative, the process is advanced to step 202, and the input signal is analyzed.

In step 204, a judgment is made whether or not the analyzed signal (input signal) is the print job data.

When the judgment result is affirmative in step 204, namely, when the input signal is judged as the print job data, the process is advanced to step 206. In step 206, the control data is extracted from the print job data, and the print job data is edited into a data having the print language format in which the control data is not reflected (a display-purpose data edit). Then, the process is advanced to step 208.

In step 208, the data having the print language format is converted into display-purpose data having the electronic document format. The process is advanced to step 210 and both the display-purpose data having the electronic document format and the control data are stored in association with each other. Then, this routine is completed.

When the judgment result is negative in step 204, namely, when the input signal is not the print job data (namely, the input signal is print instruction data or display instruction data), the process is advanced to step 212 and a sort of the instruction signal is judged.

In a case in which the input signal is judged as a reprint instruction signal in step 212, the process is advanced to step 214 and both the display-purpose data having the electronic document format and the control data are read out. Then, the process is advanced to step 216 and reprint-purpose format data is generated. The process is advanced to step 218.

In step 218, the generated reprint-purpose format data is transmitted to the output destination designation unit 104 (refer to FIG. 4). In step 220, a transmission instruction flag of the reprint-purpose format data is set, and this routine is completed.

On the other hand, when the input signal is judged as a monitor display instruction signal in step 212, the process is advanced to step 222 and the display-purpose data having the electronic document format is read out. Then, the process is advanced to step 224 and monitor display-purpose format data is generated. Thereafter, the process is advanced to step 226.

In step 226, a display process for the monitor 58D is carried out based upon the generated monitor display-purpose format data, and this routine is completed.

When the judgment result is negative in step 200, the process is advanced to step 228. In step 228, a judgment is made whether or not the transmission instruction flag has been set (flag setting process defined in step 220). When the judgment result is affirmative in step 228, the process is advanced to step 230. In step 230, a transmission process of the print-purpose format data to the image processing apparatus 56 is carried out, and this routine is completed. When the judgment result is negative in step 228, it is judged that it is not a transmission timing of the printing-purpose format data, and this routine is completed.

### Modification of First Exemplary Embodiment

In the above-described first exemplary embodiment, since the print job data is input to the server 58, the control data is extracted from the input print job data so as to generate the display-purpose data which is displayed on the monitor 58D. Alternatively, the conversion process, in which the print job data is converted into the monitor display-purpose format data based upon the display-purpose display data, may be carried out by executing a conversion process program in any other unit/location than the server 58, for example, in a control device of a computer and the like connected to the communication line network 52. In this case, the print job data, the monitor display-purpose display data, and the control data may be input to the above-described unit/location other than the server 58 so as to store in association with each other.

### Second Exemplary Embodiment

Next, a second exemplary embodiment will be explained. In the second exemplary embodiment, the same reference numerals shown in the first exemplary embodiment will be used as those for denoting the same structural elements, and explanations thereof will be omitted.

In the second exemplary embodiment, print job data is converted from data having a print language format to data having an electronic document format by reflecting control data, and thereafter, the data having the electronic document format in which the control data is reflected is edited and converted into data having an electronic document format in which the control data is not reflected. After a monitor display instruction is issued, data having the print language format is converted into the data having the electronic document format, and the data having the electronic document format is edited. Alternatively, before the monitor display instruction is issued, the data having the print language format may be converted into the data having the electronic document format, and the data having the electronic document format may be edited. Alternatively, such above-mentioned process may be carried out at timing other than such a timing when the monitor display instruction is issued.

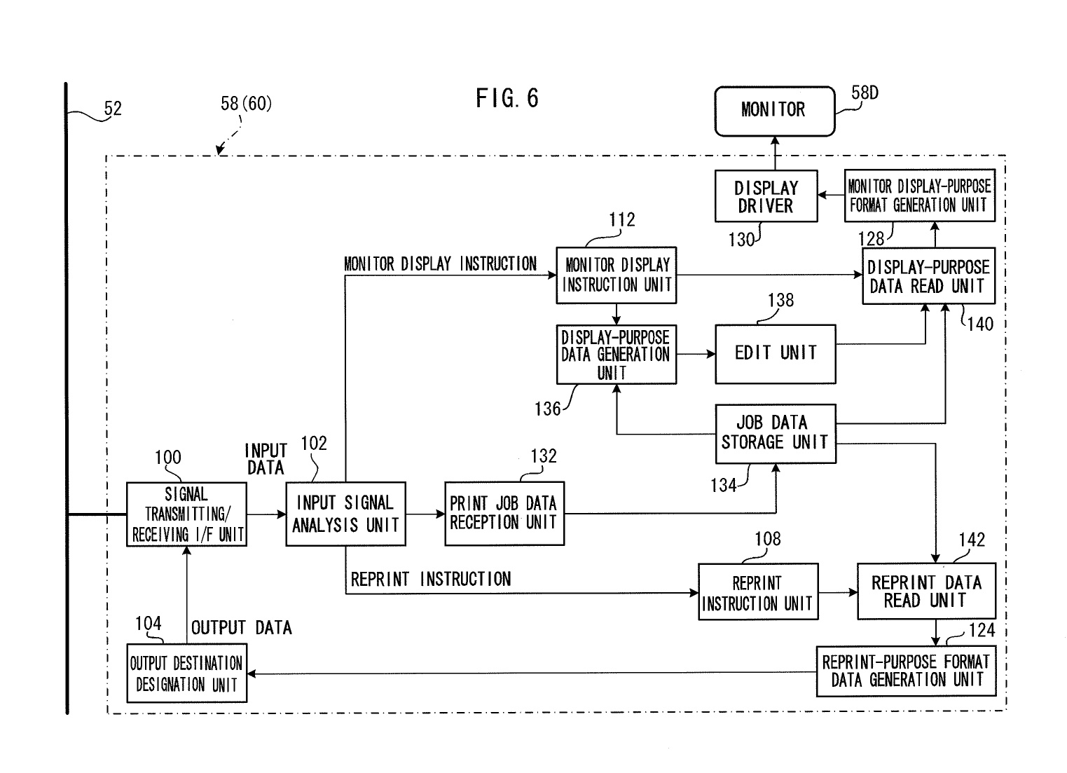

FIG. 6 shows a functional block diagram for a print job data management control executed in the main controller 60 of the server 58, according to the second exemplary embodiment. The blocks in FIG. 6 are merely classified blocks based upon functions, and therefore hardware structures are not limited to those, as similar to the first exemplary embodiment. Note that the same reference numerals used in the functional block diagram (refer to FIG. 4) shown in the first exemplary embodiment will be used as those for denoting the same structural blocks of the second exemplary embodiment, and therefore, explanations thereof will be omitted.

In a case in which the input signal analysis unit 102 analyzes that an input signal is print job data, the input signal analysis unit 102 transmits the print job data to a print job data reception unit 132.

The print job data reception unit 132 is connected to a print job data storage unit 134. The print job data storage unit 134 stores the input print job data having the print language format as is. The print job data reception unit 132 is used as one example of a reception unit.

In a case in which an analysis result of an input signal made by the input signal analysis unit 102 is a reprint instruction, the input signal analysis unit 102 transmits a reprint instruction signal to the reprint instruction unit 108.

Upon receipt of the reprint instruction signal, the reprint instruction unit 108 outputs an activation signal to a reprint data read unit 142. Based upon the activation signal, the reprint data read unit 142 reads out the print job data from the job data storage unit 134, and transmits the read data to a reprinting format data generation unit 124.

The reprinting format data generation unit 124 generates reprint-purpose data by formatting for printing based upon the print job data, and then, transmits the generated reprint-purpose data to the output destination designation unit 104. The output destination designation unit 104 transmits the received reprint-purpose data via the signal transmitting/receiving I/F unit 100 and the communication line network 52 to the image processing apparatus 56.

The print job data storage unit 134 is connected to a display-purpose data generation unit 136.

Upon receipt of an execution instruction issued from the monitor display instruction unit 112, the display-purpose data generation unit 136 converts the print job data stored in the print job data storage unit 134 into data having the electronic document format, and then, transmits the converted data having the electronic document format to an edit unit 138. In a case in which control data is contained in the print job data, the display-purpose data generation unit 136 reflects the control data to the print job data, and then, converts the reflected print job data into data having the electronic document format so as to generate the data in the electronic document format. The display-purpose data generation unit 136 is used as one example of a conversion unit.

In a case in which the print job data contains control data which is not possible to be reflected to the data having the electronic document format, the control data is described in an empty region which has no relationship with display of the data having the electronic document format. In the present exemplary embodiment, the electronic document format is PDF format, and a bookmark region of PDF format may be utilized.

The edit unit 138 performs an edit based upon the input data having the electronic document format so as to obtain data having a second electronic document format. In other words, the edit unit 138 refers to a table in which the information of the control data is stored, extracts data which is reflected by the control data from the input data having the electronic document format, and then edits the extracted data so as to obtain data in which the control data is not reflected. The edit unit 138 is used as one example of an edit unit.

When a monitor display instruction signal is input to the monitor display 112, the monitor display 112 outputs an activation signal to a display-purpose data read unit 140. Based upon the input activation signal, the display-purpose data read unit 140 reads out data having a second electronic document format from the edit unit 138 and transmits the read data to the monitor display-purpose format data generation unit 128.

The monitor display-purpose format data generation unit 128 generates monitor display-purpose data by formatting based upon the data having the second electronic document format, and then, transmits the generated monitor display-purpose data to the display driver 130. The display driver 130 transmits the received monitor display-purpose data to the monitor 58D.

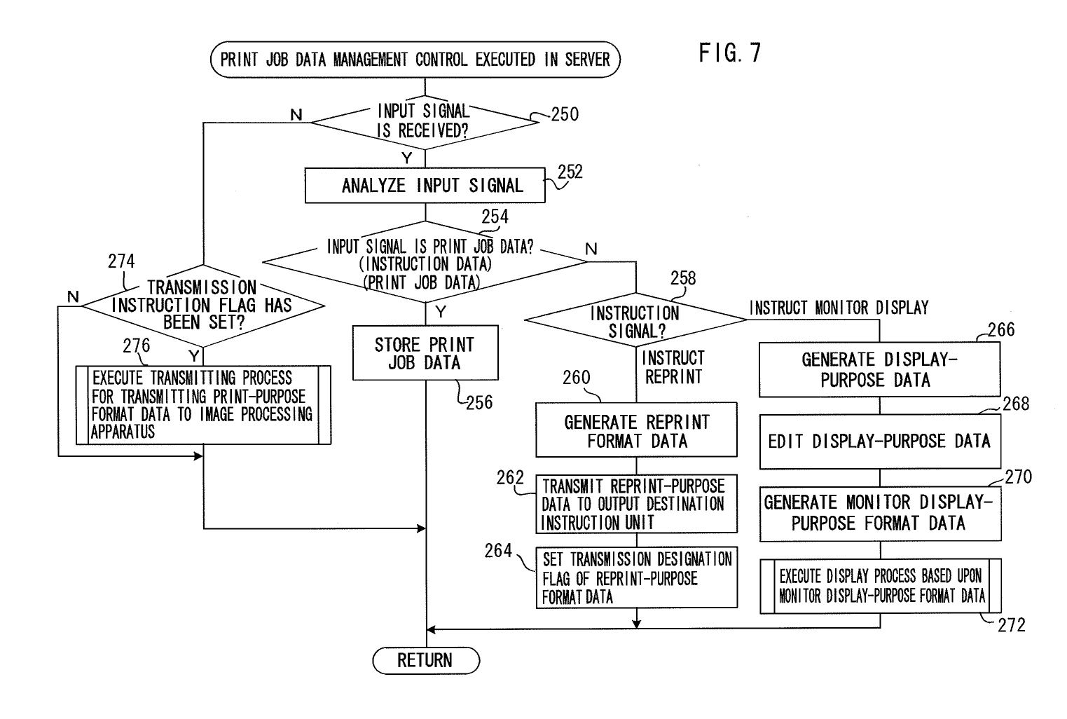

Operations of the second exemplary embodiment with reference to a flow chart shown in FIG. 7 will be described.

In step 250 of the flow chart, a judgment is made whether or not a signal has been received. When the judgment result is affirmative, the process is advanced to step 252 and the input signal is analyzed.

In step 254, a judgment is made whether or not the analyzed signal (input signal) is print job data.

When the judgment result is affirmative in step 254, namely, when the input signal is judged as the print job data, the process is advanced to step 256. In step 256, the print job data is stored, and this routine is completed.

When the judgment result is negative in step 254, namely, when the input signal is not the print job data (the input signal is print instruction data or display instruction data), the process is advanced to step 258 and a sort of an instruction signal is judged.

In a case in which the input signal is judged as a reprint instruction signal in step 258, the process is advanced to step 260 and reprint-purpose format data is generated. The process is advanced to step 262.

In step 262, the generated reprint-purpose format data is transmitted to the output destination designation unit 104 (refer to FIG. 6). In step 264, a transmission instruction flag of the reprint-purpose format data is set, and this routine is completed.

On the other hand, when the input signal is judged as a monitor display instruction signal in step 258, the process is advanced to step 266. Instep 266, the print job data is read. The read print job data is converted into data having an electronic document format. And then, display-purpose data is generated, and the process is advanced to step 268. In step 268, this data having the electronic document format is edited to generate data having a second electronic document format (display-purpose data edit). In step 270, the data having the second electronic document format is converted into monitor display-purpose format data. Then, the process is advanced to step 272.

In step 272, a display process for the monitor 58D is carried out based upon the generated monitor display-purpose format data, and this routine is completed.

When the judgment result is negative in step 250, the process is advanced to step 274. In step 274, a judgment is made whether or not the transmission instruction flag has been set (flag setting process defined in step 264). When the judgment result is affirmative, the process is advanced to step 276. In step 276, a transmission process of the print-purpose format data to the image processing apparatus 56 is carried out, and this routine is completed. When the judgment result is negative in step 274, it is judged that it is not a transmission timing of the printing-purpose format data, and this routine is completed.

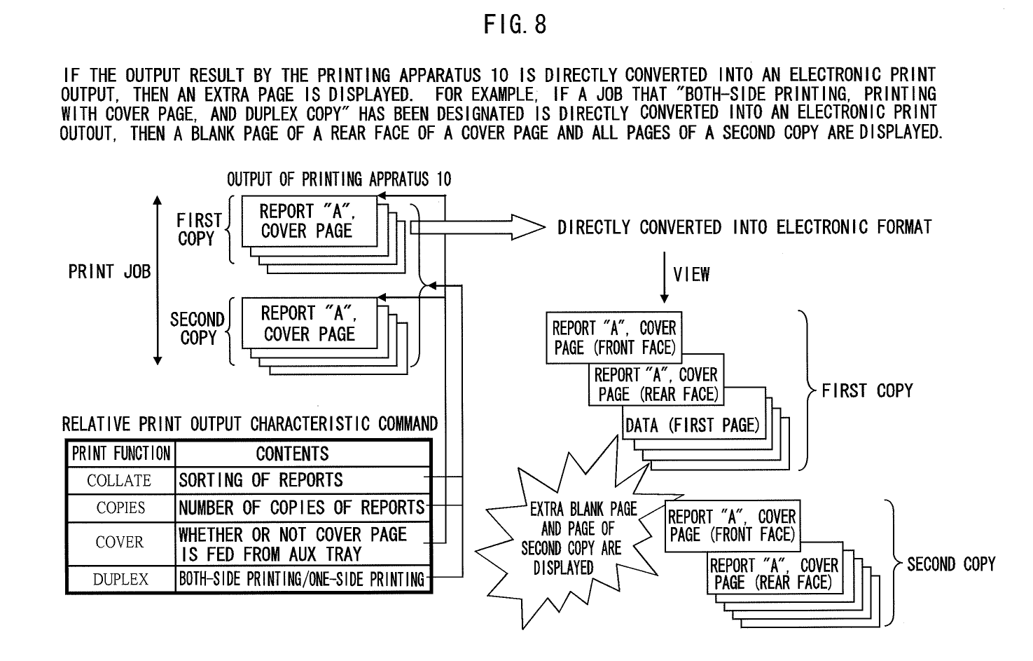

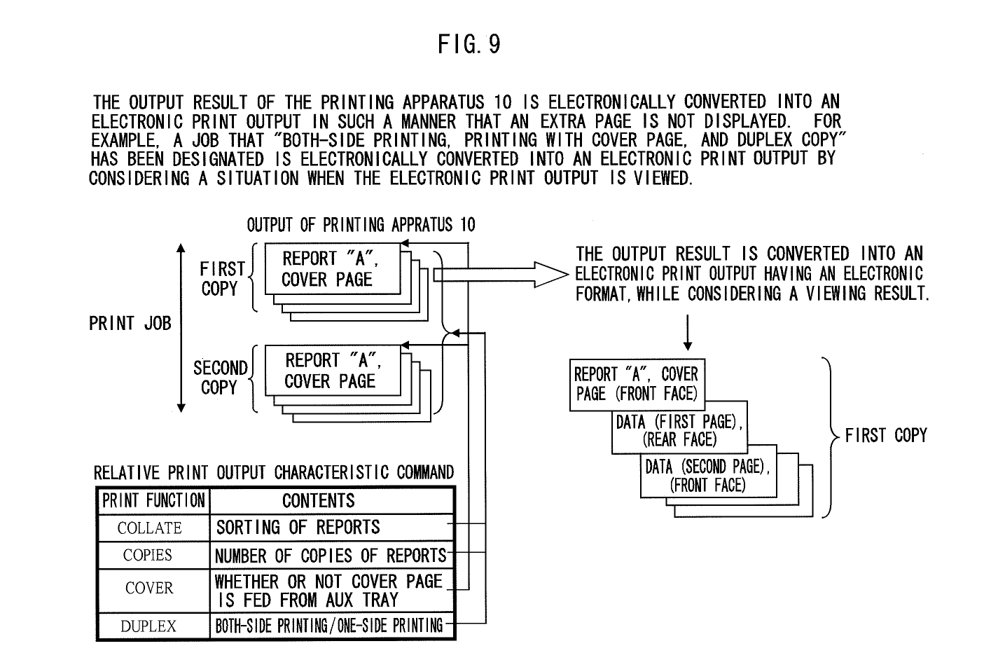

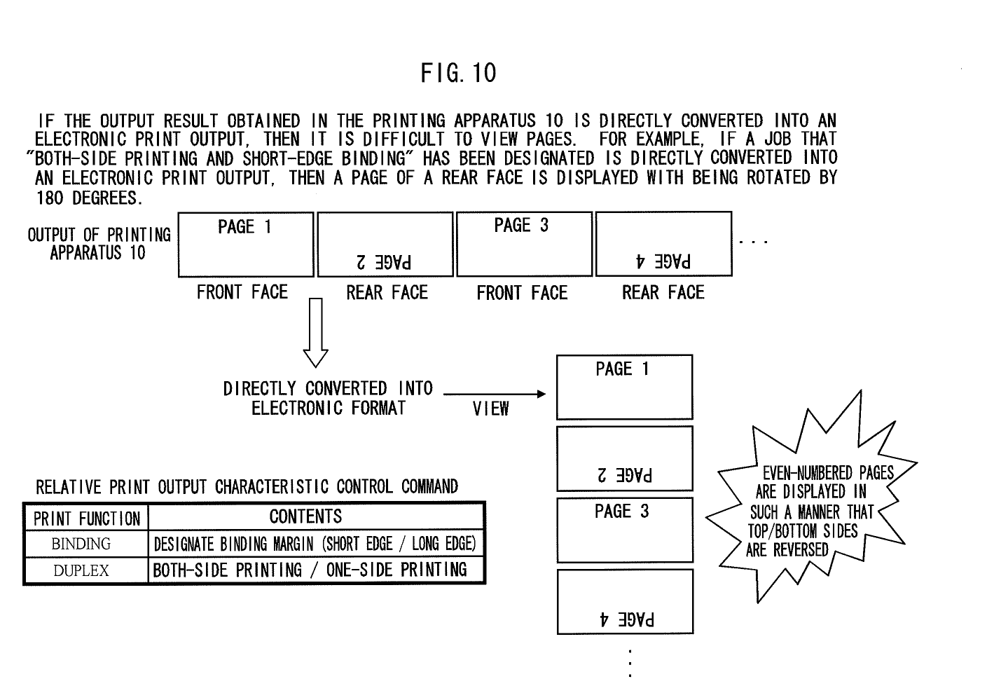

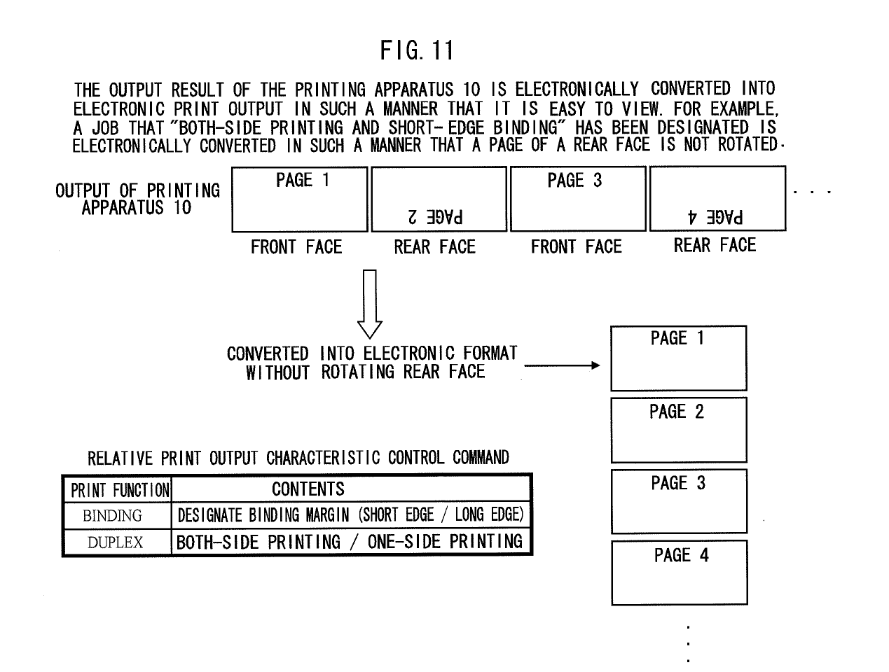

FIG. 8 and FIG. 9, and FIG. 10 and FIG. 11 show representations when the edits of the first and exemplary embodiments are carried out and when the edits are not carried out, and contents of the edit are explained.

In a case in which the edit is not carried out, the control data is reflected to a representation when data having a print language format is converted into data having an electronic document format. In other words, in a representation, the data having the print language format is directly converted into the data having the electronic document format. To the contrary, in a case in which the edit is carried out, the control data is not reflected in a representation when the data having the print language format is converted into the data having the electronic document format.

FIG. 8 shows a representation obtained without carrying out the edit in the first and second exemplary embodiments when both-side printing, printing with a front cover, and duplex copy are designated. If “COLLATE”, “COPIES”, “COVER”, and “DUPLEX” (refer to Table 1) are set to “both-side printing, printing with cover page, and duplex copy” as the print job data (print output characteristic control commands), then an extra blank page is displayed and pages of the second copy and the subsequent copies are displayed on the monitor 58D when the monitor display instruction is issued. As a result, there are too large amount of useless representations to confirm information and it is difficult for a user to view the displayed image.

In contrast to FIG. 8, FIG. 9 shows a representation obtained by carrying out the edit in the first and second exemplary embodiments when both-side printing, printing with a front cover, and duplex copy are designated. Although “COLLATE”, “COPIES”, “COVER”, and “DUPLEX” (refer to Table 1) are set to “both-side printing, printing with cover page, and duplex copy” as the print job data (print output characteristic control commands), edit is carried out in such a manner that, in considering viewing, an extra blank page is not displayed and pages of the second copy and the subsequent copies are not displayed on the monitor 58D when the monitor display instruction is issued. As a result, proper representation may be obtained in order to confirm information and it may be easy for a user to view a displayed image.

FIG. 10 shows a representation obtained without carrying out the edit in the first and second exemplary embodiments when both-side printing and short-edge binding are designated.

If “BINDING” and “DUPLEX” (refer to Table 1) are set to “both-side printing, and short-edge binding” as the print job data (print output characteristic control commands), then an even-numbered page is displayed in a state that top and bottom sides thereof are reversed on the monitor 58D when the monitor display instruction is issued. As a result, even if the image is displayed on the monitor 58D, it is difficult for a user to view the displayed image.

In contrast to FIG. 10, FIG. 11 shows a representation obtained by carrying out the edit in the first and second exemplary embodiments when both-side printing and short-edge binding are designated.

Although “BINDING” and “DUPLEX” (refer to Table 1) are set to “both-side printing, and short-edge binding” as the print job data (print output characteristic control commands), the edit is carried out such that, even if an even-numbered page is displayed on the monitor 58D when the monitor display instruction is issued, the top and bottom sides of the image thereof may match with the upper and lower sides of the monitor 58D. As a result, the image may be properly displayed in order to confirm information and it may be easy for a user to view a displayed image.

### Other Examples

In the above-described first exemplary embodiment and second exemplary embodiment, when the format data are converted for the monitor display purpose, the edit is carried out in order to avoid difficulties for viewing when the print-purpose format is displayed. Alternatively, a function for ease of viewing may be added by using a function specific to a monitor display or a function of a display (monitor 58D in present exemplary embodiment).

For example, the below-mentioned functions may be added.

(1) In a case in which a preprint has been designated, a preprint image is acquired from designated information, and the acquired preprint image is displayed, such that a print material which is actually printed may be rendered in a pseudo-manner.

(2) In a case in which a bar code has been designated, a bar-code image is acquired from designated information, and the acquired bar code image is displayed, such that a print material which is actually printed may be rendered in a pseudo-manner.

(3) Character information and image information such as a photograph are discriminated.

(4) Information relating to conversion is additionally noted, such as “this screen is a front cover”, “this screen is a rear face of a preceding page, and therefore top and bottom sides are reversed when reprinting is carried out” and the like.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. A data conversion apparatus comprising:
a reception unit that receives first data having a first format which is used for printing;
a conversion unit that converts the first data received by the reception unit into second data having a second format which is used for display;
a display that displays the second data converted by the conversion unit; and
an edit unit that performs a display-purpose edit with respect to at least one of the first data or the second data.

2. The data conversion apparatus of claim 1, wherein
the format of the first data is a print language format,
the format of the second data is an electronic document format,
the edit unit performs the display-purpose edit with respect to the first data received by the reception unit, and
the conversion unit converts the first data edited by the edit unit into the second data.

3. The data conversion apparatus of claim 1, wherein
the format of the first data is a print language format,
the format of the second data is an electronic document format,
the edit unit performs the display-purpose edit with respect to the second data converted by the conversion unit, and
the display displays the second data edited by the edit unit.

4. The data conversion apparatus of claim 1, wherein the edit unit performs as the display-purpose edit at least any one of a first edit which deletes data corresponding to a blank page, a second edit which deletes data other than data corresponding to a first copy, and a third edit which changes data corresponding to a direction of a page whose top and bottom sides have been reversed by designating a printing direction and a binding margin position.

5. The data conversion apparatus of claim 1, wherein, as the display-purpose edit, the edit unit changes designation information of a bar code image or a paper which has been previously printed into image data corresponding to the designation information.

6. A printing apparatus comprising:
a data conversion apparatus comprising:
a reception unit that receives first data having a first format which is used for printing;
a conversion unit that converts the first data received by the reception unit into second data having a second format which is used for display;
a display that displays the second data converted by the conversion unit; and
an edit unit that performs a display-purpose edit with respect to at least one of the first data and the second data.

7. The printing apparatus of claim 6, wherein
the format of the first data is a print language format,
the format of the second data is an electronic document format,
the edit unit performs the display-purpose edit with respect to the first data received by the reception unit, and
the conversion unit converts the first data edited by the edit unit into the second data.

8. The printing apparatus of claim 6, wherein
the format of the first data is a print language format,
the format of the second data is an electronic document format,
the edit unit performs the display-purpose edit with respect to the second data converted by the conversion unit; and
the display displays the second data edited by the edit unit.

9. The printing apparatus of claim 6, wherein the edit unit performs as the display-purpose edit at least any one of a first edit which deletes data corresponding to a blank page, a second edit which deletes data other than data corresponding to a first copy, and a third edit which changes data corresponding to a direction of a page whose top and bottom sides have been reversed by designating a printing direction and a binding margin position.

10. The printing apparatus of claim 6, wherein, as the display-purpose edit, the edit unit changes designation information of a barcode image or a paper which has been previously printed into image data corresponding to the designation information.

11. A computer readable medium storing a program causing a computer to execute a data conversion process, the process comprising:
receiving first data having a first format which is used for printing;
converting the received first data into second data having a second format which is used for display;
displaying the converted second data; and
performing a display-purpose edit with respect to at least one of the first data or the second data.

12. The computer readable medium of claim 11, wherein
the format of the first data is a print language format,
the format of the second data is an electronic document format,
the performing of the display-purpose edit further includes performing the display-purpose edit with respect to the received first data, and
the converting further includes converting the edited first data into the second data.

13. The computer readable medium of claim 11, wherein
the format of the first data is a print language format,
the format of the second data is an electronic document format,
the performing of the display-purpose edit further includes performing the display-purpose edit with respect to the converted second data, and
the displaying further includes displaying the edited second data.

14. The computer readable medium of claim 11, wherein, the performing of the display-purpose edit further comprises performing at least any one of a first edit which deletes data corresponding to a blank page, a second edit which deletes data corresponding to data other than a first copy, and a third edit which changes data corresponding to a direction of a page whose top and bottom sides have been reversed by designating a printing direction and a binding margin position.

15. The computer readable medium of claim 11, wherein the performing of the display-purpose edit further comprises changing designation information of a barcode image or a paper which has been previously printed into image data corresponding to the designation information.

16. A data conversion method comprising:
receiving first data having a first format which is used for printing;
converting the received first data into second data having a second format which is used for display;
displaying the converted second data; and
performing a display-purpose edit with respect to at least one of the first data and the second data.
